(19) United States
(12) Patent Application Publication
(10) Pub. No.: US 2026/0115597 A1
(43) Pub. Date: Apr. 30, 2026

(54) INFORMATION PROCESSING SYSTEM AND RECOMMENDATION APPARATUS

(71) Applicant: Nintendo Co., Ltd., Kyoto (JP)

(72) Inventors: Tetsuo HATANAKA, Kyoto (JP); Satoru MIYAHARA, Kyoto (JP); Shoma SAITO, Kyoto (JP); Toshifumi SAWAMURA, Tokyo (JP); Masayuki SENOO, Tokyo (JP); Yuki BANNO, Tokyo (JP); Koichi HAMADA, Tokyo (JP); Yoshikazu KAMOSHIDA, Tokyo (JP); Yutaka IMOTO, Tokyo (JP); Bruno L. WATANABE, Tokyo (JP); Taku TAKENAGA, Tokyo (JP); Eigo HARA, Tokyo (JP); Rin SATO, Tokyo (JP)

(21) Appl. No.: 19/371,831

(22) Filed: Oct. 28, 2025

(30) Foreign Application Priority Data
Oct. 28, 2024 (JP) 2024-188920

(51) Int. Cl. A63F 13/54; A63F 13/79

(52) U.S. Cl. CPC A63F 13/54; A63F 13/79

(57) ABSTRACT

A non-limiting example information processing system comprises a game apparatus, a game history server, a recommendation server and a user terminal respectively connected communicably with each other via a network. If a user executes a game on the game apparatus, game execution information is generated and registered in the game history server. The game history server transmits a game history of a data format to the recommendation server. The recommendation server generates recommendation information of music content based on the game history and transmits the recommendation information to the user terminal. The user terminal displays music content that is recommended based on the recommendation information.

### CROSS REFERENCE OF RELATED APPLICATION

This application claims a priority to Japanese Patent Application No. 2024-188920 filed on Oct. 28, 2024, and the entire content of which is incorporated herein by reference.

### Field

This application describes an information processing system and a recommendation apparatus, for recommending a music content.

### BACKGROUND AND SUMMARY

In an information processing system of a conventional technology, an information processing apparatus capable of executing a music playing application acquires user related information, such as user position information, pulse of the user, operations that the user performed to the information processing apparatus, etc. from sources other than the music playing application, and presumes, from the user related information acquired, a musical piece that the user may desire and presents the musical piece to the user on the music playing application.

There is room for improvement in recommending music contents according to user interests.

This application discloses a novel information processing system and recommendation apparatus.

Some example embodiments of the subject matter as described herein will be given below.

### Structure 1

In one aspect, an information processing system comprises a game apparatus, a first server, a second server and an information processing apparatus, each comprising one or more processors, and one or more memories storing instructions that, when executed, cause at least one of the one or more processors of each entity to perform operations, the operations to be performed by the one or more processors of the game apparatus comprising: transmitting a first game execution information related to a game executed by the game apparatus to the first server from the game apparatus, the operations to be performed by the one or more processors of the first server comprising: storing the first transmitted game execution information, and transmitting second game execution information, based on the first transmitted game execution information, to the second server, the operations to be performed by the one or more processors of the second server comprising: generating recommendation information based on the transmitted second game execution information and transmitting the recommendation information to the information processing apparatus, and the operations to be performed by the one or more processors of the information processing apparatus comprising: presenting a music content to be recommended based on the transmitted recommendation information, and playing the music content.

According to the structure 1, it is possible to recommend suitable music content based on the game execution information.

### Structure 2

In some embodiments of the information processing system in structure 1, at least one of the first game execution information or the second game execution information is associated with account information of either a game apparatus or a user of the game apparatus, and the recommendation information, associated with the account information, may be transmitted to the information processing apparatus associated with the account information.

According to the structure 2, since the game execution information and the recommendation information are associated with the account information, it is possible to recommend suitable music content to the user who plays the game.

### Structure 3

In some embodiments of the information processing system in the structure 1 or the structure 2, at least one of the first game execution information or the second game execution information may comprise game identification information.

According to the structure 3, since the recommendation information is generated based on game identification information, it is possible to recommend more suitable music content to the user.

### Structure 4

In some embodiments of the information processing system in the structure 3, at least one of the first game execution information or the second game execution information further may comprise execution date or time information of the game, and the recommendation information comprises a recent game information, which indicates a recently executed game or a music content associated with the recently executed game, based on the execution date or time information.

According to the structure 4, since the recommendation information comprises the execution date or time information, it is possible to recommend a more suitable music content to the user.

### Structure 5

In some embodiments of information processing system in the structure 3, the game identification information may comprise game genre information indicating the genre of the game.

According to the structure 5, it is possible to recommend a more suitable music content to a user who prefers a specific game genre.

### Structure 6

In some embodiments of the information processing system in the structure 1, at least one of the first game execution information or the second game execution information may comprise game play time information indicating cumulative time that the game has been executed.

According to the structure 6, since the recommendation information comprises, it is possible to recommend a more suitable music content to the user.

### Structure 7

In some embodiments of the information processing system in the structure 1, at least one of the first game execution information or the second game execution information may comprise game progress information indicating progress of the user in the game.

According to the structure 7, since the recommendation information comprises the progress of the user in the game, it is possible to recommend a more suitable music content to the user.

### Structure 8

In some embodiments of the information processing system in the structure 1, the operations to be performed by the one or more processors of the information processing apparatus further comprises transmitting to the second server input information based on an input to the information processing apparatus, and the recommendation information is generated based on the transmitted input information.

According to the structure 8, since the recommendation information is generated based on the input information to the information processing apparatus, it is possible to recommend a more suitable music content for a user by taking the input by the user into consideration.

### Structure 9

In some embodiments of the information processing system in the structure 2, the recommendation information is generated based on the game execution information associated with further account information different from the account information.

According to the structure 9, it is possible to recommend a music content using the game execution information associated with the further account information. Therefore, for example, if the further account information is an account information of a further user who is a friend of the user, it is possible to recommend a music content associated with a friend to the user.

### Structure 10

In one aspect, an information processing system comprises a game apparatus associated with account information, one or more servers and an information processing apparatus associated with the account information, wherein the game apparatus stores instructions that, when executed, cause the game apparatus to perform first operations comprising: transmitting to the one or more servers, game content identification information for identifying a selected game content, the information processing apparatus storing instructions that, when executed, cause the information processing apparatus to perform operations comprising: transmitting to the one or more servers, music content identification information for identifying a selected music content, the one or more servers storing instructions that, when executed, cause the one or more servers to perform second operations comprising: storing the transmitted game content identification information in association with the account information, and storing the transmitted music content identification information in association with the account information, the first operations further comprising, presenting a game content to be recommended based on the music content identification information associated with the account information that is acquired from the one or more servers, and the second operations further comprising, presenting a music content to be recommended based on the game content identification information associated with the account information that is acquired from the one or more servers.

According to the structure 10, it is possible to recommend a music content in the information processing apparatus based on a specific game, and it is possible to recommend a game content in the game apparatus based on a specific musical piece.

### Structure 11

In some embodiments of the information processing system in the structure 10, wherein the game content identification information comprises game content identification information of the selected game content, executed in the game apparatus.

According to the structure 11, since the game content identification information comprises game content identification information of the selected game content, it is possible to recommend more suitable music content to the user.

### Structure 12

In one aspect, a recommendation apparatus comprises one or more processors, and one or more memories storing instructions that, when executed, cause at least one of the one or more processors to perform operations comprising: generating recommendation information based on game execution information related to a game that is executed by a game apparatus, and transmitting the recommendation information to an information processing apparatus so that the information processing apparatus presents a music content to be recommended based on recommendation information and plays the music content.

According to the structure 12, it is possible to recommend to the user a suitable music content based on the game execution information.

### Structure 13

In some embodiments of the recommendation apparatus in the structure 12, wherein the game execution information is associated with account information of either a game apparatus or a user of the game apparatus, and the recommendation information is associated with the account information, and the recommendation information, associated with the account information, is transmitted to an information processing apparatus associated with the account information.

According to the structure 13, since the game execution information and the recommendation information are associated with the account information, it is possible to recommend suitable music content to the user who plays the game.

### Structure 14

In some embodiments of the recommendation apparatus in the structure 12, wherein the game execution information comprises game identification information.

According to the structure 14, since the recommendation information is generated based on game identification information, it is possible to recommend more suitable music content to the user.

### (structure 15

In some embodiments of the recommendation apparatus in the structure 14, wherein the game execution information further comprises execution date or time information of the game, and the recommendation information comprises a recent game information, which indicates a recently executed game or a music content associated with the recently executed game, based on the execution date or time information.

According to the structure 15, since the recommendation information comprises the execution date or time information, it is possible to recommend a more suitable music content to the user.

### Structure 16

In some embodiments of the recommendation apparatus in the structure 14, wherein the game identification information comprises game genre information indicating the genre of the game.

According to the structure 16, it is possible to recommend a more suitable music content to a user who prefers a specific game genre.

### Structure 17

In some embodiments of the recommendation apparatus in the structure 12, wherein the game execution information comprises game play time information indicating cumulative time that the game has been executed.

According to the structure 17, since the recommendation information comprises, it is possible to recommend a more suitable music content to the user.

### Structure 18

In some embodiments of the recommendation apparatus in the structure 12, wherein the game execution information may include game progress information indicating progress of the user in the game.

According to the structure 18, since the recommendation information comprises the progress of the user in the game, it is possible to recommend a more suitable music content to the user.

### (structure 19

In some embodiments of the recommendation apparatus in the structure 12, wherein the recommendation information is generated based on input information to the information processing apparatus, transmitted from the information processing apparatus.

According to the structure 19, since the recommendation information is generated based on the input information to the information processing apparatus, it is possible to recommend a more suitable music content for a user by taking the input by the user into consideration.

### Structure 20

In some embodiments of the recommendation apparatus in the structure 13, wherein the recommendation information is generated based on game execution information associated with further account information different from the account information.

According to the structure 20, it is possible to recommend a music content using the game execution information associated with the further account information. Therefore, for example, if the further account information is an account information of a further user who is a friend of the user, it is possible to recommend a music content associated with a friend to the user.

The aspects, structure, features and advantages of the embodiment(s) will become more apparent from the following detailed description when taken in conjunction with the accompanying drawings.

### BRIEF DESCRIPTION OF THE DRAWINGS

FIG. 1 is a view showing non-limiting example structure of an information processing system of an embodiment.

FIG. 2 is a block diagram showing non-limiting example electrical structure of a game apparatus shown in FIG. 1.

FIG. 3 is a block diagram showing non-limiting example electrical structure of a recommendation server shown in FIG. 1.

FIG. 4 is a block diagram showing non-limiting example electrical structure of a user terminal shown in FIG. 1.

FIG. 5 is a view showing a non-limiting example home screen displayed on a display of the user terminal shown in FIG. 1.

FIG. 6 is a view showing a non-limiting example search screen displayed on the display of the user terminal shown in FIG. 1.

FIG. 7 is a view showing a non-limiting example playing screen displayed on the display of the user terminal shown in FIG. 1.

FIG. 8 is a chart showing a non-limiting example flow from game execution on the game apparatus to display of a music content on the user terminal.

FIG. 9 is a view showing a non-limiting example home screen displayed on the display of the user terminal in a second embodiment.

### DETAILED DESCRIPTION OF NON-LIMITING EXAMPLE EMBODIMENTS

### First Embodiment

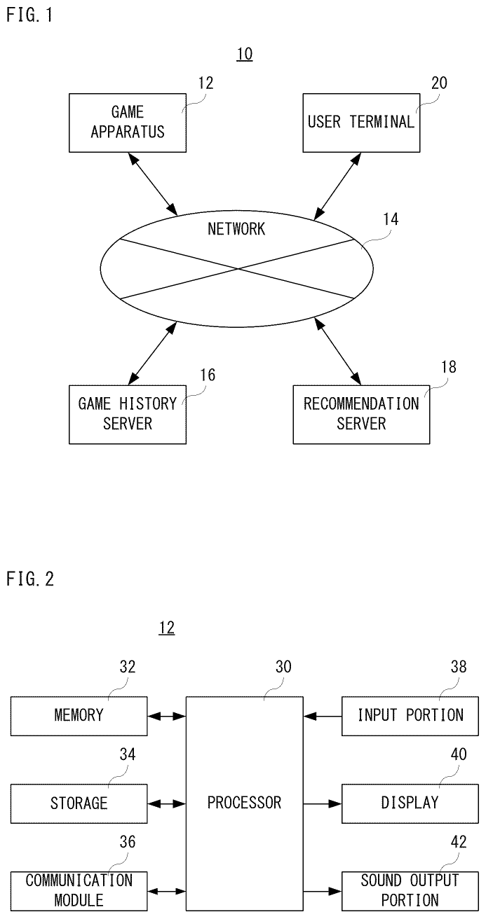

With reference to FIG. 1, a non-limiting example information processing system 10 includes a game apparatus 12, a game history server 16, a recommendation server 18 and a user terminal 20. The game apparatus 12, the game history server 16, the recommendation server 18 and the user terminal 20 are communicably connected to each other via a network 14.

Although FIG. 1 shows a single game apparatus 12 used by a user, a plurality of game apparatuses 12 of the same type or different types used by the user may be provided. Moreover, when a plurality of game apparatuses 12 are provided, a game executed in each of two or more game apparatuses 12 may be the same or may differ. Although illustration is omitted, the same applies to a game apparatus(es) used by a further user, and one or more game apparatuses 12 will be provided. Moreover, a plurality of users may use a single game apparatus 12.

Moreover, a single game history server 16 is shown in FIG. 1. The game history servers 16 may be provided in plural number. For example, a plurality of the game history servers 16 may be provided for each type of game apparatus 12. Furthermore, a single recommendation server 18 is shown in FIG. 1. The recommendation servers 18 may be provided in plural number. For example, a plurality of recommendation servers 18 may be provided for each country and/or region. The game history server 16 and the recommendation server 18 may be so-called virtual servers. Moreover, when there are a plurality of game history servers 16, a part of processing for realizing a specific function and other parts may be executed by different servers, respectively. This is the same also for the recommendation server 18. Furthermore, a single user terminal 20 used by the user is shown. A plurality of user terminals 20 used by the user of the same type or different types may be provided. Although illustration is omitted, the same applies to a user terminal(s) 20 used by a further user(s), and one or more user terminals 20 will be provided.

The game apparatus 12 should just be an information processing apparatus capable of executing a game, and may be a portable game device, a stationary game machine, a PC, a cellular phone, a smart phone, a tablet terminal or a wearables terminal, for example. The game apparatus 12 includes an information processing apparatus that can substantially execute a game with techniques, such as streaming, mirroring, and cloud gaming. The game history server 16 and the recommendation server 18 are information processing apparatuses each having a function to provide predetermined service via the network 14. The user terminal 20 should just be an information processing apparatus that can be connected to the network, and may be a portable game device, a stationary game machine, a PC, a cellular phone, a smart phone, a tablet terminal or a wearables terminal, for example. The game apparatus 12 and the user terminal 20 may be virtual terminals executed by an information processing apparatus. Moreover, in another embodiment, the game apparatus 12 and the user terminal 20 may be the same information processing apparatus.

FIG. 2 shows non-limiting example electrical structure of the game apparatus 12 shown in FIG. 1. As shown in FIG. 2, the game apparatus 12 includes a processor 30 to which a memory 32, a storage 34, a communication module 36, an input portion 38, a display 40 and sound output portion 42 are connected. Each element constituting the game apparatus 12 may be formed integrally or attachable and detachable element. Moreover, connection among respective components may be a wired-connection or wireless connection.

The processor 30 is a processing entity of the game apparatus 12. In this disclosure, the processor means processing circuits, such as CPU, MPU, GPU, etc. Moreover, the processor may include an SoC (System-on-a-chip) in which a plurality of functions, such as VRAM (Video Random Access memory), etc.

The memory 32 is a volatile storage medium, and is used as a working memory and a buffer memory of the processor 30, for example. The storage 34 is a non-volatile storage medium, and is used in order to store a program(s) of game and to store various kinds of data, for example. The storage 34 may be a storage medium that is attachable to or detachable from the game apparatus 12 like a cartridge or an optical disk, for example.

For example, a program(s) of game and data required for executing the game are read from the storage 34, are stored in the memory 32. Moreover, the processor 30 generates image data for displaying a screen on the display 40 using the data that is for generating an image and stored in the memory 32, etc., and outputs the generated image data to the display 40.

In this disclosure, the program of game should just be a program that includes an element(s) of game, while not being limited to a program mainly concerned with a game. Such a program includes various types of programs that can be executed on the game apparatus 12 like a document creation program, an email program, etc., for example.

The communication module 36 performs communication with an external apparatus(es) via the network 14. The communication module 36 has a hardware required for wired-communication and/or wireless communication. The communication module 36 performs communication with the external apparatus(es) including other game apparatus(es) of the same type with a predetermined communication system.

The input portion 38 receives an operation of the user who controls the game apparatus 12. The input portion 38 may include a game controller, a touch panel, a mouse, a keyboard, a microphone, etc., for example. The input portion 38 may be an interface with an apparatus that receives a user operation (e.g., game controller). That is, the apparatus receiving the user operation may exist in an outside of the game apparatus 12.

The display 40 displays an image generated as a result of the information processing executed by the processor 30. The display 40 includes an LCD or an OLED, for example. In addition, the display 40 may exist in an outside of the game apparatus 12. In this case, the game apparatus 12 may also include an interface circuit with the display 40.

The sound output portion 42 performs an output based on sound data applied from the processor 30. The sound output portion 42 includes a speaker, for example, and performs a sound output based on the data that is applied from the processor 30, which is converted into an analog sound signal by a D/A converter. An output by the sound output portion 42 is not limited to a sound, and may be a sound signal to be output by a connected external speaker, for example.

FIG. 3 shows non-limiting example electrical structure of the recommendation server 18 shown in FIG. 1. Moreover, although illustration is omitted, non-limiting example electrical structure of the game history server 16 shown in FIG. 1 is also the same.

As shown in FIG. 3, the recommendation server 18 includes a processor 60 to which a memory 62, a storage 64 and a communication module 66 are connected. Each element constituting the recommendation server 18 may be formed integrally or attachable and detachable element. Moreover, connection among respective components may be wired-connection or wireless connection. Moreover, the recommendation server 18 may be a dedicated information processing apparatus for communicating with the game apparatus 12 and/or the game history server 16, or may be realized using a general-purpose server.

The processor 60 is a processing entity of the recommendation server 12. The memory 62 is a volatile storage medium, and is used as a working memory and a buffer memory of the processor 60, for example. The storage 64 is a non-volatile storage medium, and is used in order to store a program(s) and to store various kinds of data, for example. An information processing program executable by the processor 60 and data required therefor are read from the storage 64, and stored in the memory 62. The communication module 66 performs communication with an external apparatus(es) via the network 14.

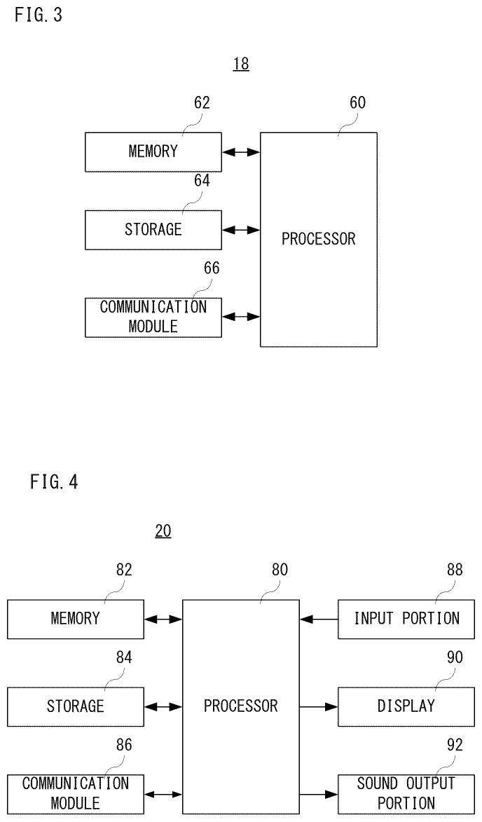

FIG. 4 shows a non-limiting example electrical structure of the user terminal 20 shown in FIG. 1. As shown in FIG. 4, the user terminal 20 includes a processor 80 to which a memory 82, a storage 84, a communication module 86, an input unit 88, a display 90 and a sound output portion 92 are connected. Each element constituting the user terminal 20 may be formed integrally or attachable and detachable element. Moreover, connection among respective components may be wired-connection or may be wireless connection.

The processor 80 is a processing entity of the user terminal 20. The memory 82 is a volatile storage medium, and is used as a working memory and a buffer memory of the processor 80, for example. The storage 84 is a non-volatile storage medium, and is used in order to store a program(s) of music application and to store various kinds of data, for example. A program executable by the processor 80 and data required therefore are read from the storage 84, and stored in the memory 82. The communication module 86 performs communication with an external apparatus(es) via the network 14. The input portion 88 receives an operation of the user who controls the user terminal 20. The input portion 38 may include a touch panel, a button(s), a microphone, etc., for example. The display 90 displays an image generated as a result of the information processing executed by the processor 80. The sound output portion 92 performs an output based on sound data applied from the processor 80. The sound output portion 92 outputs a sound based on sound data related to a music content applied from the processor 80, for example. In the first embodiment, a music content means music data of a musical piece or a plurality of musical pieces. Formats of the plurality of musical pieces are not to be specified. For example, it may be music data compiled in a form of playlist or album. Moreover, a music content includes videos containing sound, single sound, sound effects, BGMs, narration, etc.

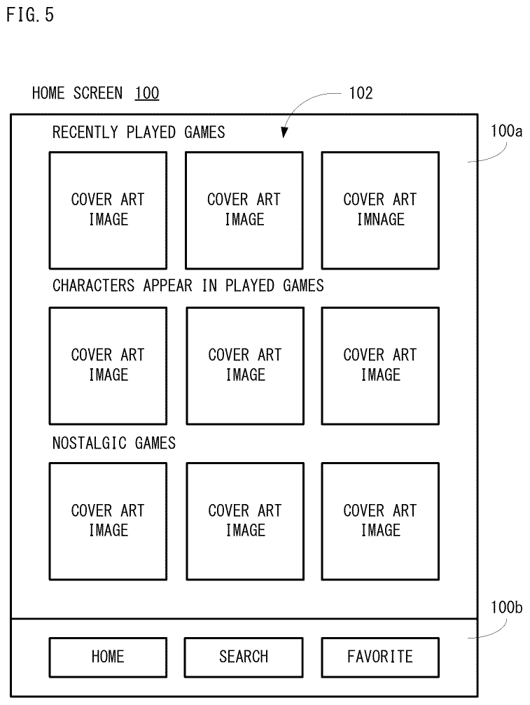

In the first embodiment, the user terminal 20 can execute an application capable of playing the music distributed in a music distribution service (hereinafter, referred to as “music application”). What is shown in FIG. 5 is a non-limiting example home screen 100 in the music application. The home screen 100 is displayed as an initial screen when the music application is executed, for example. The music application may include an internet browser, in such a case, an entity of execution may be an external information processing terminal.

When executing or using the music application, it may be needed or possible to log-in to the music distribution service using an ID and authentication information having been registered in advance (hereinafter, referred to as “account information”). Moreover, an account information server for managing the account information may be provided. In the first embodiment, the account information used in the music distribution service is associated with the game apparatus 12, and includes information related to the user in addition to the ID and the authentication information.

The information related to the user may include information including a friend list, a level of the account information, a purchase history of game, a purchase history of musical piece, etc.) in addition to personal information of the user (e.g., a name, nationality, a region of a home, sex, a language, a birthday, etc.).

The account information server may be provided in plural number. For example, a music account information server that manages account information used in a music service and a game account information server that manages account information associated with the game apparatus 12 are provided separately, and the account information existing in respective servers may be linkable with each other. Moreover, it may be possible to log-in to the game apparatus 12 or the game distribution service distributing a game that can be played with the game apparatus 12 using the account information associated with the game apparatus 12.

The home screen 100 shown in FIG. 5 includes a display area 100a where images 102 each indicating a music content is displayed and a display area 100b where a UI for transiting to other screens in the music application is displayed. A displaying manner of the music contents in the home screen 110 is not limited to a manner that a plurality of images 102 are displayed side by side longitudinally and laterally as shown in FIG. 5. For example, an image 102 corresponding to a single music content is displayed, and may be changeable by a swipe input etc. Moreover, the display area 100b may always be displayed also in another screen different from the home screen 100.

In the first embodiment, each of a plurality of images 102 displayed in the home screen 100 is associated with a music content. Each of the images 102 is a cover image associated with a music content or an image related to a game associated with a music content (hereinafter, referred to as “related game”). The image related to the related game is an image of a scene in the game when executing the related game, an image of a character that appears in the related game or a title image of the related game, for example. Moreover, the image related to the related game may be an image that a title logo or a character string of a title of the related game is superposed thereon, for example.

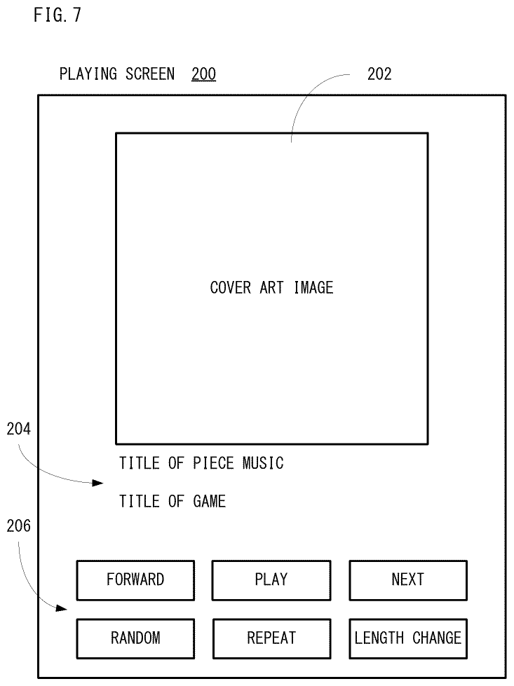

In the first embodiment, when performing an input targeting the image 102, a screen is transited to a playing screen 200 (see FIG. 7) for playing a music content associated with the image 102. A transition destination is not limited to the playing screen 200, but may also be a screen that displays details of the associated music content, for example.

Moreover, the transition destination may be an image on which a title logo of the music content or the character string of the title of the game is superimposed. In the first embodiment, when performing an input targeting the image 102, a screen is transited to the playing screen 200, and then, transited to a screen for playing a music content associated with the image 102. A transition destination is not limited to the playing screen 200, but may also be a screen that displays details of the associated music content, for example.

In the first embodiment, a plurality of images 102 are displayed according to recommendation information acquired from the recommendation server 18. The recommendation information is information indicating a music content(s) to recommend to the user. The recommendation information in the first embodiment includes identifiers that are given in an array format and for identifying a plurality of music contents, and based on the identifiers, a plurality of images 102 each corresponding to each of the music contents are displayed in the home screen 100.

Although the identifier for identifying the music content is a music content inherent identifier by which a music content can be directly identified, should not be limited to this, may include an identifier of the associated game, for example. In this case, the associated music content may be specified based on the identifier of the related game and displayed by the music application. Moreover, the format of the recommendation information is not limited to the array, and if an array, the dimension is not limited. Moreover, the recommendation information may include information concerning a displaying position of the music content to be recommended in the home screen 100. The recommendation information may be a list including only an identifier of each of the music contents, for example. Moreover, the recommendation information may be image data including the image 102 corresponding to each of the music contents, for example.

In the first embodiment, the recommendation information is generated by the recommendation server 18 based on game history information given from the game history server 16. The game history information is transmitted by the game history server 16 based on information concerning a game executed on the game apparatus 12 (hereinafter, referred to as “game execution information”). The game history information may be the same as the game execution information, or may be generated based on the game execution information, or may include a part of the game execution information. Moreover, the game history information may be transmitted to the recommendation server 18 by acquiring a part of the game execution information stored in the game history server 16 based on a request by the recommendation server 18.

The game execution information includes game identification information, play information, etc., for example, and is associated with the user account information. Among information that can be included in the game execution information described below, information that is not included as the game execution information may be included in the game history information or the recommendation information. In this case, information that was not included as the game execution information may be added in the game history server 16 or the recommendation server 18. When the information that was not included as the game execution information is to be added, for example, addition of the information may be requested to an external server, or information to be added may be generated by the game history server 16 or the recommendation server 18 based on the game execution information or the game history information. Moreover, the information to be added is not limited to the information that can be included in the game execution information. For example, it may be information based on the game execution information associated with account information of a further user, for example. Moreover, it may be holding information on an event relevant to that game and release information on a game relevant to that game, for example.

The game identification information is information for identifying a game, and is an identifier for identifying a game, for example. The game identification information may be other information, such as a game title and a predetermined character string assigned to a game. Moreover, the game identification information may be an identifier that indicates a collection including a plurality of games, such as a genre of game, a series of game, a predetermined game group, etc. Moreover, the game identification information may also include detailed information concerning games, such as a release date of game, for example. Moreover, the game execution information may include the game identification information concerning two or more games. Moreover, the game execution information may hold multiple data for the same game executed at different timings, for example. In this case, the game execution information may also include the same game identification information associated with different play information in plural number. Moreover, not only the game identification information but the game execution information may include information concerning a plurality of games, or may hold only a single piece of game execution information to generate in plural number. Moreover, when executing a single game a plurality of times, the game execution information may be generated each time, or the same game execution information may be updated.

The play information is information indicating a play situation of the game by the user, and includes play time information and play situation information, for example. The play information is associated with the game identification information in the first embodiment.

The play time information is information concerning a time period among information indicating the play situation of the game by a user. The play time information includes first play information concerning date or time that the user firstly played the game, last play information concerning date or time that the user lastly played the game, and cumulative time information concerning a total amount of time period that the user has played the game, for example. The play situation information includes platform identification information concerning a platform that the user played the game and play contents information concerning details of a game play, for example.

By using the last play information or information based thereon when generating the recommendation information, it is possible to display, on the music application, preferentially a music content related to the game that the user recently played, for example.

For example, in a case where the platform identification information is not included in the game execution information but included in the game history information, and the game history server 16 is provided for each type of game apparatus 12, when the recommendation server 18 acquires the game history information, the platform identification information may be added by the recommendation server 18 based on the game history server 16 that acquires the game history information. Not only this, some information may be added to the game history information in the game history server 16 or the recommendation server 18.

The play contents information is information concerning the details of the game play. The play contents information is information concerning selection by the user in the game, for example. As an example, the play contents information is information indicating what player character the user selected when the user selected a player character to be used among a plurality of candidates. Moreover, as another example, the play contents information may be information concerning a boss the user beat in the game or a completed event. Moreover, as another example, the play contents information may be information for progress of the game, such as an achievement rate that indicates how many of a plurality of events have been completed, a level of the player character, types of characters and items possessed by the user, and predetermined parameters and/or conditions that have been met in the game. The information concerning the progress of the game may be managed in the game history server 16 for each game or collectively for a plurality of games. When managing collectively for a plurality of games, the information concerning the progress of the game may be managed per each account information, for example. The information concerning the progress of the game collected for a plurality of game may be a level of the account information that increases with completion of achievable mission in each game that is determined in advance, for example. Moreover, not only the progress of the game, the level of the account information may increase based on the cumulative play time of the game, for example.

By using the play contents information or information based thereon when generating the recommendation information, it is possible to preferentially include a music content associated with the experienced event or the used character when the user played a game, for example. Moreover, it is possible not to spoil a game experience of the user by not including in the recommendation information a music content associated with the game that the user is playing and with an event that has not experienced yet, for example.

Thus, it is possible to recommend a suitable music content to the user by presenting to the user a music content according to the recommendation information generated based on the history of the game that the user played.

The recommendation information in the first embodiment is generated by the recommendation server 18 based on the game history information so as to include a plurality of music contents to be recommended. Among them, a plurality of music contents that satisfy a predetermined condition are grouped together. A group is a collection of a plurality of music contents constituting a predetermined row in the recommendation information given in the two-dimensional array format, for example. The recommendation server 18 may classify the music content into a group after determining the music contents to recommend, may determine the music content applicable to the group after determining a group to recommend, or may perform these complexly. Moreover, for example, as to the group having been determined based on the game history information, a music content to be included in the group may be determined not based on the game history information, or as to a predetermined group, a music content to be included in the predetermined group may be determined based on the game history information. That is, it is sufficient that at least one of the determination of a group and the determination of a music content is performed based on the game history information. Moreover, a group that is not based on the game history information including a music content determined without being based on the game history information may be included. Moreover, the predetermined music content may belong to a plurality of groups.

The predetermined condition for a music content is to be included in the group may be based on the game history information, and may not need to be based.

A group that satisfies the predetermined condition based on the game history information is, for example, a group including an identifier of the related game to the game identification information, and including an identifier of the related game to the game identification information, and including a music content associated with a game that the user has played (hereinafter, referred to as “played game”).

Moreover, a group that satisfies the predetermined condition based on a game history information is, for example, a group including a music content associated with a boss the user has defeated or character the user has played, which including an identifier of a predetermined boss or character is included in the play situation information (hereinafter, referred to as “character appeared in the played game”). In this case, a character that appears in the applicable game may be acquired separately based on the game identification information.

Moreover, a group that satisfies the predetermined condition based on the game history information is, for example, a group including a music content associated with a game the user played within a predetermined number of days prior to generation of the recommendation information based on the game identification information and the play date or time information (hereinafter, referred to as “game played recently”).

Moreover, a group that satisfies the predetermined condition based on the game history information is, for example, a group including a music content associated with a game that the release day of the game included in the game identification information before the predetermined year or period (hereinafter, referred to as “nostalgic game”). In this case, a music content included in a group of the nostalgic game may be selected based on the date of release of a platform using the platform identification information.

A group that satisfies the predetermined condition not based on the game history information is, for example, a group including a music content a larger number of play times within a predetermined period based on playing record of all users who use the music distribution service.

In the first embodiment, a group included in the recommendation information is determined by the recommendation server 18 out of a plurality of predetermined groups. A group included in the recommendation information may be determined in advance, may be determined based on a music content that has been determined previously in the recommendation information, may be determined separately based on priority information, or may be determined with these complexed. The priority information is information that is generated in the recommendation server 18 and indicates a degree of recommendation to the user in correspondence to each music content or each group (hereinafter, referred to as “priority”). The priority information may be included in the recommendation information, and the recommendation information may be generated based on the priority information. Moreover, the priority information may be determined for all the music content or group that can be included in the recommendation information, or may be generated for a part thereof. Moreover, the priority information may be determined for only the music content or group included in the recommendation information.

The priority information is determined based on the game history information. For example, based on the cumulative time information included in the game history information, the priority of the group or the music content using the game history information is set higher for the user who plays the game for long time.

Moreover, the priority information may be determined based on information other than the game history information. For example, the priority of the group or the music content that the user is interested in may be set higher using an operation record or input information in the music application.

Moreover, the priority information may be determined as an example based on the account information. For example, with reference to check-in information on an event that is associated with the account information and performed by off-line or on-line, the priority of the music content corresponding to the event may be set higher. Moreover, with reference to the time of visiting a specific institution associated with the account information, the priority of the music content that is played in the specific institution at that time may be set higher.

As shown in FIG. 5, in the first embodiment, respective groups are displayed to be developed in the lateral direction in the home screen 100, and character strings indicating respective groups are also displayed. A display format is not limited to this, and the number and the types of the group are not limited to those shown in FIG. 5. In the first embodiment, positions that respective music contents and respective groups are to be stored in the array included in the recommendation information are determined according to the priority assigned to each music content and each group, and according to the array, a position in an up and down direction of the groups and a position of the image 102 corresponding to the music content included in the group in a left and right direction are determined. Moreover, as to positions of the groups and the images 102 corresponding to respective music contents in the array and the screen in the music application, a part or all of them may be positions determined in advance. What determined based on the priority is not limited to the position of the image 102. For example, according to the priority of the music content, a size of the corresponding image 102 may be determined. Moreover, as to a music content having the priority exceeding a predetermined threshold value, a display that emphasizes the corresponding image 102 may be performed.

In the first embodiment, the position of each music content in the group, that is, the identifier corresponding to the music content is stored in which element in the predetermined row of the array, is also determined based on the priority information. The priority information or the priority of each music content may be determined based on different conditions for each group including that music content. For example, as to the group of the “game played recently”, based on the play time information, the more recent the last play of the related game is, the higher the priority of the related music content may be set. For example, as to the group of the “nostalgic game”, based on the play time information, the older the release date of the related game, the higher the priority of the related music content may be set. For example, as to the group of the “character appeared in the played game”, based on the game identification information and/or the play time information, the longer the cumulative play time of a plurality of games associated with the character, or the more games associated with the character that have been played, the higher the priority of the music content related to the character may be set.

Moreover, the priority information or the priority may be determined based on a plurality of conditions. Moreover, the condition to determine the priority may be common among a plurality of groups. For example, based on both the priority information determined for each group and the priority information determined based on the common condition for a plurality of groups, final priority information that is included in the recommendation information or is for generating the recommendation information may be determined. As an example, that the priority information is determined based on the common condition for a plurality of groups, in a case where a musical piece that is played in the related game is a music content associated with the predetermined time, a time signal, for example, the priority may be set higher.

Moreover, for example, based on the play time information, as to the user that a total of the cumulative play times of all the games (hereinafter, referred to as “total play time”) is larger than a predetermined value, the priority of a music content or group preferred by a person who spends a lot of time playing game may be higher. In this case, the music content preferred by a person who spends a lot of time playing game may be determined based on a use history of each account information using the music distribution service, or may be set in advance. Accordingly, it is possible to preferentially recommend a musical piece preferred by a person who spent a lot of time laying game to a user who spent a lot of time playing game.

Moreover, for example, based on the game identification information, the priority of the music content or group associated with a game the user has not played may be set higher. For example, as to a user that the total play time is smaller than a predetermined value or a user that the game identifier included in the game identification information is smaller than a predetermined value, by adopting the above-described structure, it is possible to provide an opportunity for a user who does not play games very often and a user who plays a small number types of games to try a new game.

Moreover, for example, based on the cumulative time information, a cumulative time is totalized for each genre to which each game belongs for a plurality of games, the priority of the music content or group associated with the game belonging to the genre that the cumulative play time is long or the music content or group preferred by another user who likes the genre that the cumulative play time long may be set higher.

Moreover, the music content distributed in the music distribution service may include a music content directly or indirectly related to a game. For example, based on the total play time included in the play time information and the time that the user executed the predetermined application not a game, it may be permissible to change how much extent that music content associated with the game is to be included in the music content that is recommended. That is, the priority of the music content associated with the game may be set higher.

Moreover, a predetermined element in the music application may be changed based on the recommendation information or the game history information. For example, based on the game history information, an image of the character associated with the game title having been played may be displayed on a splash screen, that is displayed by the time the initial home screen 100 is displayed after the user executes the music application. The image of the character may be displayed on not only the splash screen but on an image in the music application, for example, an icon image of the music application, various UI images or a background image. Moreover, not only the image of the character but a predetermined image related to the game, such as a related item, a game title, etc. may be displayed. Moreover, not only displaying the image, for example, but a music content associated with a game title having been played may be played when a predetermined screen is being displayed, or according to a predetermined operation in the music application. The music content to be played may be a sound effect in the game, for example. Moreover, any music contents, for example, a sound effect, may be played according to an input on a screen or an image related to a predetermined game, irrelevant to the game history information.

Moreover, there may be a group in which only music contents related to a predetermined game is included (hereinafter, referred to as “game group”). Moreover, not limited to the group, but only such a music content may be displayed in a predetermined screen in the music application (hereinafter, referred to as “game feature screen”). For example, the image 102 corresponding to a predetermined game is displayed on the home screen 100, and may be transited to the game feature screen based on an input to the image 102. Moreover, due to a reason that there are different versions with close contents or it has been remade, etc., as to each of a plurality of games that a music content associated with them is the same or approximately the same, different images 102 are displayed, and the game feature screen that is transition designation may be the same. Moreover, a display position of the music content in the game group and the game feature screen may be determined based on the game history information or the recommendation information. Moreover, in the game group and the game feature screen, the music content associated with not only a single game but a plurality of games that belong to a predetermined series, for example may be included.

Moreover, not only the game, but a group or screen in which only a music content associated with a predetermined type of the game apparatus 12 (hereinafter, referred to as “game apparatus feature screen”) may exist. The game apparatus feature screen may be transited to the game feature screen related to a game that can be played on the game apparatus 12, for example. In this case, the image 102 corresponding to each game that can be transited to the game feature screen may be arranged based on the game execution information, for example.

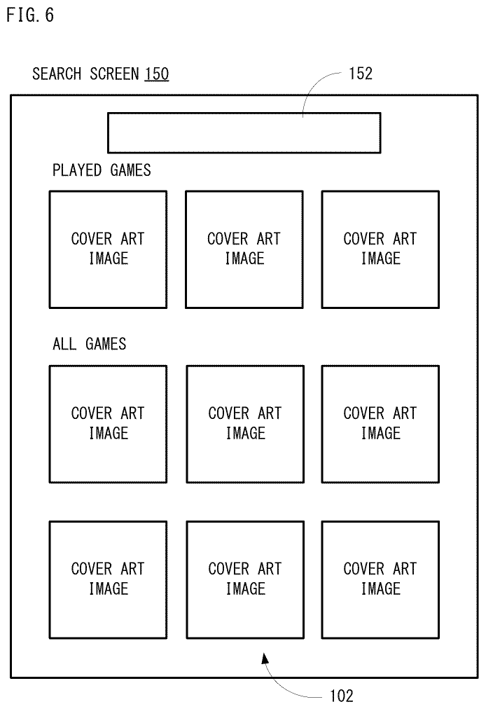

FIG. 6 shows a non-limiting example search screen 150 that may be included in the music application. The search screen 150 is a screen for searching a music content distributed in the music distribution service, and includes an input area 152, in the first embodiment. In the first embodiment, the search screen 150 can be transited by performing an input to the UI included in the display area 100b.

The user can search a music content distributed in the music distribution service by inputting a keyword into the input area 152. The predetermined music content is associated with information, a title, a genre, a title of the related game, a series of the related game, a related character, etc., for example, and a search is performed by comparing input information with such information. Moreover, not all of this information is necessarily associated with all music content. A search target is not only the music content but may be the game feature screen and the group, for example. Moreover, the input in the first embodiment is not limited to a keyword. For example, a search according to a sound or an image may be available. In this case, an input may be performed by a microphone and a camera.

The search screen 150 may include the image 102 associated with the music content or the game feature screen, as similar to the home screen 100, for example. It is possible to assist a search by the user by arranging based on the game history information the image 102 associated with the game feature screen on the music content related the user or the related game.

As for any predetermined music content that was not in the search result, it may be possible for the user to send a request for adding that music content to the music distribution service. A target for a request is not limited to a music content; a title of the related game may be requested.

FIG. 7 shows a non-limiting example playing screen 200 for playing a music content. In the first embodiment, the playing screen 200 includes an image 202 associated with the music content, a character string 204 indicating the music content and an operation UI 206 concerning with a play of the music content.

The images 202 associated with the music content may be an image that is the same as the image 102 associated with the music content but has a different size. Moreover, the images 202 may be an image different from the corresponding image 102. For example, an image that is captured by the game apparatus 12 when the user is playing the related game may be displayed as the image 202. Moreover, as to the music content played in the related game, an image of a scene of the related game in which the music content is included may be displayed as the image 202.

As to the image 102 and the image 202, when including a character string such as a title of a game, for example, based on language information or regional information linked to the music application or the account information, an image based on the language information or the regional information may be displayed as the image 102 and/or the image 202. Moreover, not only a case of including a character string, an image based on the language information or the regional information may be displayed as the image 102 and/or the image 202.

The character string 204 that indicates a music content includes a title of the music content and a title of the related game, for example. Moreover, the character string 204 may also include a name of the related character.

The operation UI 206 includes various UIs required when performing the operation in the playing screen. For example, a UI for controlling play/pause of the music content, a UI for changing to play of another music content, a UI for performing control to repeat play the same music content after the end of the play of the music content, etc. are included.

The operation UI 206 may also include a UI for controlling a loop play that adjusts a length of the music content to a predetermined length and plays it, for example. Moreover, a UI for performing control for purchasing to the related game, for example may also be included. For example, a UI for performing control for acquiring the related game while performing access the game distribution service may also be included. In this case, it is necessary to log-in the game distribution service using the account information; however, if it is possible to log-in to both the game distribution service and the music distribution service according to the same account information, log-in processing may be performed automatically using the account information at the time of using the music distribution service.

The operation UI 206 may include a UI for controlling sharing of the music content that is currently being played on an SNS (social networking service), for example. In this case, in the SNS capable of sharing information including a text, for example, a contribution including a text may be automatically generated based on an input to the operation UI 206, and texts a linkage for opening a music content and for describing the music content may be automatically input into that contribution. In this case, by making a title of the music content not be included and only a title of the related game be included in the texts, it is possible to prevent the user from unintentionally encountering information on the related game based on the title of the musical piece. The text may be a tag, for example.

Moreover, although the selected music content can be played in the first embodiment, a playable music content may be determined based on the game identification, or information acquired from the account information server or the game distribution service, for example. For example, a music content related to only a game that the user has a playing experience made to be playable. For example, as for games other than those purchased by the user, only some of the music content may be playable.

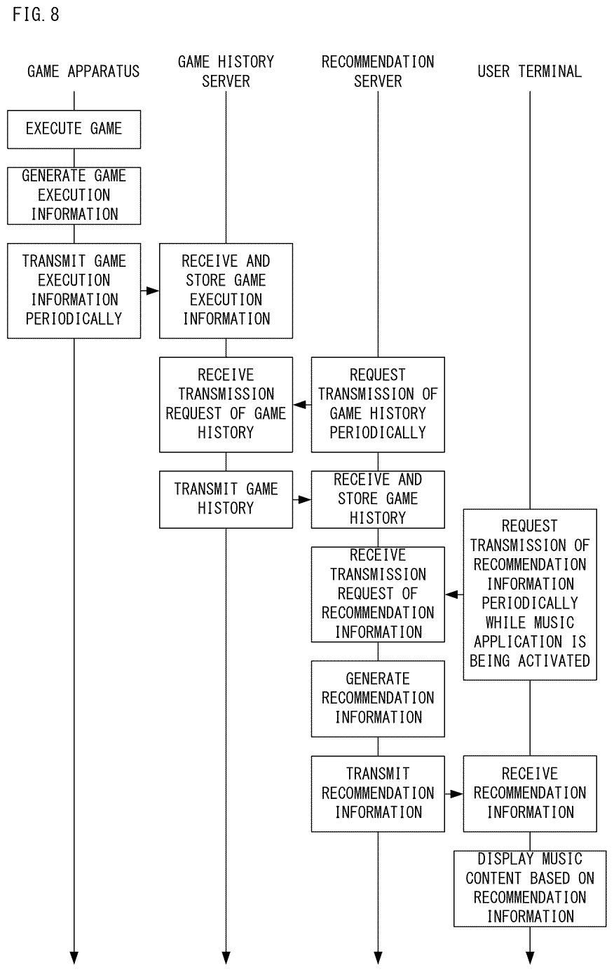

FIG. 8 is a chart showing non-limiting example processing of the game apparatus 12, the game history server 16, the recommendation server 18 and the user terminal 20 until the user is presented a music content that is recommend in the user terminal 20 after a game has been executed on the game apparatus 12. Each processing executed in each apparatus is executed by either the processor 30 that is a processor included in each apparatus, the processor of the game history server 16, the processor 60 or the processor 80. In this case, each processing may be executed by the processor in cooperation with respective elements coupled to the processor, for example, the communication module.

The game apparatus 12 executes game processing based on an input by the user. The game processing may be executed on the game apparatus 12, or may be executed on another information processing apparatus(es) communicably connected to the game apparatus 12.

In the game apparatus 12, when the game is ended, the game execution information is generated. The game execution information may be generated after the end of the game, and may be generated periodically. Moreover, the game execution information may be generated according to a request of the game execution information by the game history server 16. Moreover, the game execution information may be generated at the time of a start of the game.

Moreover, the game execution information is associated with the account information of the game apparatus 12 or the user. Association may be performed by the game apparatus 12 or by the game history server 16 to which the game execution information is transmitted. Moreover, the association may be performed using the account information acquired from an external account information server.

The game apparatus 12 transmits periodically the game execution information to the game history server 16 at the predetermined time every day, for example. The game execution information may be transmitted whenever the game execution information is generated, transmitted whenever the game apparatus 12 establishes connection with the game history server 16, or transmitted in response to a request from the game history server 16.

Moreover, the game execution information may be transmitted in plural number at the same time. For example, when a plurality of users operate a single game apparatus 12, the game execution information associated with each of the plurality of users may be transmitted at the same time.

The game history server 16 stores the received game execution information in the storage in a state of being associated with the account information. Respective game execution information may be stored individually, or may be stored integrally.

The game history server 16 transmits the game history information based on the game execution information to the recommendation server 18 in response to a request from the recommendation server 18. The game history information may be periodically transmitted to the recommendation server 18, or may be transmitted to the recommendation server 18 when the game history information receives the game execution information. In the first embodiment, the game history server 16 transmits to the recommendation server 18 in a data format as requested the game history information based on information included in the game execution information, in response to a request via an API (Application Programing Interface) of the recommendation server 18.

The recommendation server 18 stores the received game history information in the storage 64 in a state of being associated with the account information. In addition, the recommendation server 18 stores the game history information as it is when the game identifier included in the game history information is not the same, and when the game identifier included in the game history information is the same, only a difference of the game history information may be stored.

The user terminal 20 requests to the recommendation server 18 periodically a transmission of the recommendation information. The transmission request of the recommendation information may be performed at the time of the start of the music application, for example. Moreover, such a transmission request may be performed when a predetermined condition is satisfied, when a predetermined time elapses after the start of the music application, or when being transited to the home screen 100, for example. Moreover, in this case, the user terminal 20 may transmit to the recommendation server 18 other information such as the above-described operation record or the input information in the music application, for example. Moreover, a timing that such other information is not limited to the above-described timings, and may be transmitted in response to a request from the recommendation server 18, for example.

The recommendation server 18 generates, based on a transmission request of the recommendation information according to the user terminal 20, the recommendation information based on the game history information to transmit to the user terminal 20 that is a request source. Generation of the recommendation information does not need to be performed based on the transmission request of the recommendation information according to the user terminal 20, and may be performed based on a reception of the game history information, or may be performed periodically, for example. That is, the generation and the transmission of the recommendation information may be performed at different timings. Moreover, the transmission of the recommendation information from the recommendation server 18 to the user terminal 20 does not need to be performed in response to the transmission request from the user terminal 20. For example, the recommendation information may be transmitted periodically, or may be transmitted at the time of the generation or the update of the recommendation information.

The user terminal 20 receives the recommendation information and displays the home screen 100 as shown in FIG. 5 on the display 90 based on the received recommendation information.

Thus, according to the first embodiment, since the game execution information, the game history information and the recommendation information are associated with the game apparatus 12 or the account information of the user of the game apparatus 12, it is possible to recommend the music content in the music distribution service and the music application with using the same account information or using the account information associated with the same account information. That is, it is possible to recommend the suitable music content to the user.

In addition, although the home screen 100 is displayed based on the recommendation information in this first embodiment, a screen that is displayed based on the recommendation information is not limited to the home screen 100, and for example, the display of another screen, such as the search screen 150, may be changed based on the recommendation information that is received. Moreover, a matter that is performed based on the recommendation information is not limited to the display of a screen. For example, a music content that is recommended on the predetermined screen in the music application may be played based on the recommendation information. Moreover, for example, a music content that is recommended may be displayed based on the recommendation information as a playlist within the music application.

Moreover, although the recommendation server 18 recommends a musical piece to be played in the music application in the first embodiment based on the game history information, should not be limited to this.

As an example, the recommendation server 18 may recommend a game or a game content in the game distribution service based on the information associated with the account information of the user in the music distribution service. Moreover, at the same time, the recommendation server 18 may recommend a music content based on the information associated with the account information of the user in the game distribution service or the game history information. A music content is recommended based on the game that the user plays usually, and a game or game content is recommended based on the musical piece that the user listens usually. The game content may be, for example, an item that unlocks a music content that can be played in the game.

As another example, the recommendation server 18 may recommend a music content to be played by the music application based on the game history information, and a music content used within the game using a music content based on the information associated with the account information of the user in the music distribution service. For example, as to a game in which the user performs a predetermined input in time with the music content being played, a music content used within the game may be recommend.

Moreover, although recommendation of a music content on the user terminal 20 with which the account information that is the same as the account information of a user is performed based on the game execution information of the user in the first embodiment, should not be limited to this. For example, the recommendation server 18 may recommend a music content based on the game execution information or the game history information of another user who has a predetermined relation with the user. That is, in generating the recommendation information, the information concerning with the game play by another user may be used. The predetermined relationship is a friend, a user having the same regional information and language information, for example. Moreover, the recommendation information for the user may be generated based on further information of other users. For example, the further information may be the operation record of the music application by other users.

Moreover, although a case where the game execution information is transmitted to the game history server 16 from the game apparatus 12 was described in the first embodiment, the game history server 16 may not be included in the system, and the game execution information may be transmitted to the recommendation server 18 from the game apparatus 12. In this case, the game execution information is stored by the storage 64 in the recommendation server 18. Moreover, the game history server 16 and the recommendation server 18 may be realized by the same server.

Moreover, a push notification linked with the game apparatus 12 may be transmitted by the user terminal 20. For example, the push notification to prompt the user a start of the music application may be transmitted in time with the start or the end of the game on the game apparatus 12.

Moreover, although a case where the game history server 16 transmits the game history information to the recommendation server 18, and the recommendation information is generated in the recommendation server 18 using the information of the game having been played based on the game history information was described in the first embodiment, should not be limited to this, and for example, the user inputs the game having been played in the music application, and the game history information may be generated based on the input.

### Second Embodiment

Since an information processing system 10 according to the second embodiment is the same as or similar to the first embodiment except that when the image 102 is displayed in various types of screens of the music application in the user terminal 20a, a displaying manner of the image 102 corresponding to a music content that became an exclusion target based on exclusion information is changed, a duplicate description will be omitted.

The exclusion information is information that is set by the user in the music distribution service, the music application or the user terminal 20, and includes a predetermined condition concerning with a music content. The predetermined condition concerning with a music content is a predetermined related game and character, a series of the related game, etc., and when these are included in the exclusion information, a music content with which these are associated is made to be an exclusion target by the exclusion information, for example. The exclusion information may also include automatically a game that the user has not played based on the game history information without setting by the user, for example. According to this, it is possible to prevent the user from unintentionally encountering information on a game that the user has not played.

Moreover, the exclusion information is not limited to a case of including the exclusion target, and may include information related to a target that is not an exclusion target, and a music content may be made to be an exclusion target based on information related to a target that is not an exclusion target.

The exclusion information may include the genre information of the game, and a music content associated with the related game that is associated with a predetermined game genre selected by the user may be made to be an exclusion target. Accordingly, it is possible to prevent the musical piece that the user does not desire from being displayed.

A change of the displaying manner may be a change from a state where the image 102 is being displayed to a state of being non-displayed, for example, and may be replacement of the image 102 to another image. An image to replace may be common to the image 102 corresponding to a plurality of or all the music contents, for example.

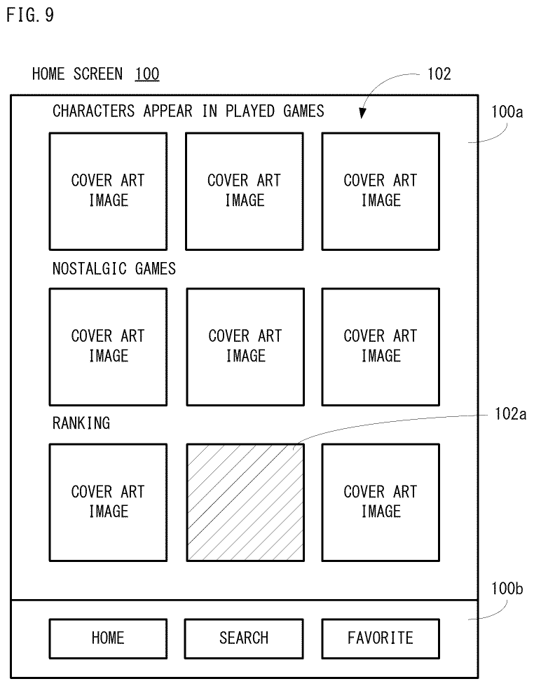

FIG. 9 is a view showing a non-limiting example home screen 100 of the second embodiment. An image 102a is the image 102 that corresponds to a music content that is made to be an exclusion target based on the exclusion information, and the displaying manner thereof has been changed. As to not only the image 102 but also to an element associated with the music content having been made to be the exclusion target, the displaying manner may be changed. Moreover, a screen that the displaying manner is changed is not limited the home screen 100. For example, in the screen on which a playlist including a music content that has been made to be an exclusion target, the music content that becomes the exclusion target may be non-displayed.

Moreover, the exclusion information may be transmitted to the recommendation server 18 from the user terminal 20, for example. In this case, at the time of generation of the recommendation information in the recommendation server 18, the exclusion information is used, so that a music content made to be an exclusion target by the exclusion information is not recommended. In order to realize this processing, a judgment on whether a music content made to be an exclusion target by the exclusion information is included may be performed separately, and the priority of each music content may be changed. Moreover, these processing may be performed not only in the recommendation server 18 but in the music application.

Also in the second embodiment, it is possible to recommend a suitable music content to the user, as similar to the first embodiment.

Moreover, in the second embodiment, by changing the displaying manner in the music application for some music contents, it is possible to prevent the user from unintentionally knowing information of a game, or to prevent a music content that the user does not desire from being presented.

In addition, the structure of the information processing system, respective types of screens and specific numeral values described in the above-described embodiments are mere examples, should not be limited, and changeable according to actual products.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. An information processing system comprising a game apparatus, a first server, a second server and an information processing apparatus, each comprising one or more processors, and
one or more memories storing instructions that, when executed, cause at least one of the one or more processors of each entity to perform operations,
the operations to be performed by the one or more processors of the game apparatus comprising:
transmitting a first game execution information related to a game executed by the game apparatus to the first server from the game apparatus,
the operations to be performed by the one or more processors of the first server comprising:
storing the first transmitted game execution information, and
transmitting second game execution information, based on the first transmitted game execution information, to the second server,
the operations to be performed by the one or more processors of the second server comprising:
generating recommendation information based on the transmitted second game execution information and transmitting the recommendation information to the information processing apparatus, and
the operations to be performed by the one or more processors of the information processing apparatus comprising:
presenting a music content to be recommended based on the transmitted recommendation information, and
playing the music content.

2. The information processing system according to claim 1, wherein
at least one of the first game execution information or the second game execution information is associated with account information of either a game apparatus or a user of the game apparatus, and
the recommendation information, associated with the account information, is transmitted to the information processing apparatus associated with the account information.

3. The information processing system according to claim 1, wherein
at least one of the first game execution information or the second game execution information comprises game identification information.

4. The information processing system according to claim 3, wherein
at least one of the first game execution information or the second game execution information further comprises execution date or time information of the game, and
the recommendation information comprises a recent game information, which indicates a recently executed game or a music content associated with the recently executed game, based on the execution date or time information.

5. The information processing system according to claim 3, wherein
the game identification information comprises game genre information indicating the genre of the game.

6. The information processing system according to claim 1, wherein
at least one of the first game execution information or the second game execution information comprises game play time information indicating cumulative time that the game has been executed.

7. The information processing system according to claim 1, wherein
at least one of the first game execution information or the second game execution information comprises game progress information indicating progress of the user in the game.

8. The information processing system according to claim 1, wherein
the operations to be performed by the one or more processors of the information processing apparatus further comprises transmitting to the second server, input information based on an input to the information processing apparatus, and
the recommendation information is generated based on the transmitted input information.

9. The information processing system according to claim 2, wherein
the recommendation information is generated based on game execution information associated with further account information different from the account information.

10. An information processing system comprising a game apparatus associated with account information, one or more servers and an information processing apparatus associated with the account information, wherein
the game apparatus stores instructions that, when executed, cause the game apparatus to perform first operations comprising:
transmitting to the one or more servers, game content identification information for identifying a selected game content,
the information processing apparatus storing instructions that, when executed, cause the information processing apparatus to perform operations comprising:
transmitting to the one or more servers, music content identification information for identifying a selected music content,
the one or more servers storing instructions that, when executed, cause the one or more servers to perform second operations comprising:
storing the transmitted game content identification information in association with the account information, and
storing the transmitted music content identification information in association with the account information,
the first operations further comprising, presenting a game content to be recommended based on the music content identification information associated with the account information that is acquired from the one or more servers, and
the second operations further comprising, presenting a music content to be recommended based on the game content identification information associated with the account information that is acquired from the one or more servers.

11. The information processing system according to claim 10, wherein the game content identification information comprises game content identification information of the selected game content, executed in the game apparatus.

12. A recommendation apparatus comprising one or more processors, and
one or more memories storing instructions that, when executed, cause at least one of the one or more processors to perform operations comprising:
generating recommendation information based on game execution information related to a game that is executed by a game apparatus, and
transmitting the recommendation information to an information processing apparatus so that the information processing apparatus presents a music content to be recommended based on recommendation information and plays the music content.

13. The recommendation apparatus according to claim 12, wherein
the game execution information is associated with account information of either a game apparatus or a user of the game apparatus, and
the recommendation information is associated with the account information, and the recommendation information, associated with the account information, is transmitted to an information processing apparatus associated with the account information.

14. The recommendation apparatus according to claim 12, wherein the game execution information comprises game identification information.

15. The recommendation apparatus according to claim 14, wherein
the game execution information further comprises execution date or time information of the game, and
the recommendation information comprises a recent game information, which indicates a recently executed game or a music content associated with the recently executed game, based on the execution date or time information.

16. The recommendation apparatus according to claim 14, wherein
the game identification information comprises game genre information indicating the genre of the game.

17. The recommendation apparatus according to claim 12, wherein
the game execution information comprises game play time information indicating cumulative time that the game has been executed.

18. The recommendation apparatus according to claim 12, wherein
the game execution information may include game progress information indicating progress of the user in the game.

19. The recommendation apparatus according to claim 12, wherein
the recommendation information is generated based on input information to the information processing apparatus, transmitted from the information processing apparatus.

20. The recommendation apparatus according to claim 13, wherein
the recommendation information is generated based on game execution information associated with further account information different from the account information.
